(19) United States
(12) Patent Application Publication
(10) Pub. No.: US 2024/0069310 A1
(43) Pub. Date: Feb. 29, 2024

(54) MOBILE ELECTRONIC DEVICE WITH LENS, AND LENS ASSEMBLY

(71) Applicant: SAMSUNG ELECTRO-MECHANICS CO., LTD., Suwon-si (KR)

(72) Inventors: Tae Kyung LEE, Suwon-si (KR); Byung Ju KIM, Suwon-si (KR); Jung Ho LEE, Suwon-si (KR); Na Yi KANG, Suwon-si (KR); Joung Hun KIM, Suwon-si (KR); Jae Goon AUM, Suwon-si (KR)

(73) Assignee: SAMSUNG ELECTRO-MECHANICS CO., LTD., Suwon-si (KR)

(21) Appl. No.: 18/184,962

(22) Filed: Mar. 16, 2023

(30) Foreign Application Priority Data
Aug. 25, 2022 (KR) 10-2022-0106947

(51) Int. Cl. G02B 13/00; G02B 1/18

(52) U.S. Cl. CPC G02B 13/0055; G02B 1/18; G02B 5/208; G02B 2207/101

(57) ABSTRACT

A lens includes a lens unit; an intermediate layer configured to cover a surface portion of the lens unit; and a water-repellent layer, configured to cover a surface portion of the intermediate layer, including a base layer and an ultraviolet (UV) absorber disposed in the base layer.

### CROSS-REFERENCE TO RELATED APPLICATION(S)

This application claims the benefit under 35 USC 119(a) of Korean Patent Application No. 10-2022-0106947 filed on Aug. 25, 2022, in the Korean Intellectual Property Office, the entire disclosure of which is incorporated herein by reference for all purposes.

### BACKGROUND

### 1. Field

The present disclosure relates to a mobile device with lens, and lens assembly.

### 2. Description of Related Art

Camera functions used for a mobile electronic device such as a mobile phone, a tablet personal computer (PC), and a laptop PC have advanced, and so has the technology of the lenses. The lens may serve to converge and disperse light. The lens can enlarge and reduce an image size based on its straight and refractive characteristics. Thus, it is possible to enlarge and reduce an image size based on light passing through the lens using these two characteristics. In addition, a view through the lens is different from an actual view, and the camera thus uses a lens that can capture a wider or more magnified view than a view seen with a naked eye. However, light may spread or distort rather than converge at a point in the refraction process, and this phenomenon may be referred to as aberration. Aberration can distort an image of the lens when taking a photo and affect its sharpness, which results in lower resolution; however, a combination structural characteristics and different types of lenses used in the camera may be used to correct the problem.

However, light incident on the lens may cause internal reflection on the surface, inner wall, or the like, of the lens, which may cause a flare phenomenon on a screen. Therefore, minimizing light transmittance and light reflectance in a visible light region may be desirable to prevent the flare phenomenon. In addition, a water-repellent layer may be used to protect the lens from a foreign material, a water droplet, or the like. In this case, the lens may have lower reliability when the water-repellent layer is damaged because the lens is exposed to an external environment for a long time.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens includes a lens unit, an intermediate layer configured to cover a surface portion of the lens unit, and a water-repellent layer, configured to cover a surface portion of the intermediate layer, including a base layer and an ultraviolet (UV) absorber disposed in the base layer.

The UV absorber may include inorganic particles.

The inorganic particles may include at least one selected from a group consisting of cerium dioxide (CeO₂), zinc oxide (ZnO), titanium dioxide (TiO₂), and tungsten trioxide (WO₃).

The inorganic particle may include a nano-sized inorganic particle.

The nano-sized inorganic particle may have a diameter of 50 nm or less.

A diameter of the inorganic particle may be smaller than a thickness of the base layer.

The UV absorber may further include an organic material.

The inorganic particles in the UV absorber may have an area ratio of 10% or less to a unit area of the water-repellent layer.

The intermediate layer may include at least one material layer selected from a group consisting of siloxane, silicon dioxide (SiO₂), silicon oxynitride (SiON), silicon nitride (Si₃N₄), titanium dioxide (TiO₂), titanium oxynitride (TiON), and titanium nitride (TiN).

The intermediate layer may have a multilayer structure in which a first layer and a second layer, having different refractive indices, and are alternately stacked one or more times.

A portion of the UV absorber may be in contact with the intermediate layer.

All of the UV absorber may be in contact with the intermediate layer.

The lens may further include a UV absorbing layer disposed between either one or both of the water-repellent layer and the intermediate layer, and the lens unit and the intermediate layer.

A thickness of the UV absorbing layer may be smaller than a thickness of the water-repellent layer.

The UV absorbing layer may include an inorganic material.

The UV absorber may be disposed to contact the UV absorbing layer.

A mobile electronic device may include a lens assembly including one or more lenses, wherein at least one lens among the one or more lenses includes the lens described herein; and a display unit disposed on the lens assembly.

In another general aspect, a lens assembly includes one or more lenses, wherein at least one lens among one or more lenses includes a lens unit, an intermediate layer configured to cover a surface portion of the lens unit, and a water-repellent layer, configured to cover a surface portion of the intermediate layer, including a base layer and an ultraviolet (UV) absorber disposed in the base layer.

The at least one lens may be disposed on an outermost side of the lens assembly in an optical axis direction.

In another general aspect, a mobile electronic device includes a display unit and a lens assembly including one or more lenses, and at least one lens among the one or more lenses includes a lens unit, an intermediate layer configured to cover a surface portion of the lens unit, and a water-repellent layer, configured to cover a surface portion of the intermediate layer, including a base layer and an ultraviolet (UV) absorber disposed in the base layer.

The at least one lens may be disposed on an outermost side of the lens assembly in the optical axis direction.

The lens assembly may be covered by the display unit.

The lens assembly may be covered by tempered glass.

Other features and aspects will be apparent from the following detailed description, the drawings, and the claims.

### BRIEF DESCRIPTION OF DRAWINGS

FIG. 1 is a cross-sectional view schematically illustrating a lens according to one or more embodiments of the present disclosure.

FIGS. 2 through 10 are enlarged views of a region of the lens of FIG. 1.

FIG. 11 is a cutaway perspective view schematically illustrating a lens assembly.

FIGS. 12 and 13 are perspective views schematically illustrating a mobile electronic device, and respectively showing its front and rear parts.

FIGS. 14 and 15 are cross-sectional views respectively showing enlarged peripheral regions of the lens assembly shown in FIGS. 12 and 13.

Throughout the drawings and the detailed description, the same reference numerals refer to the same or like elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

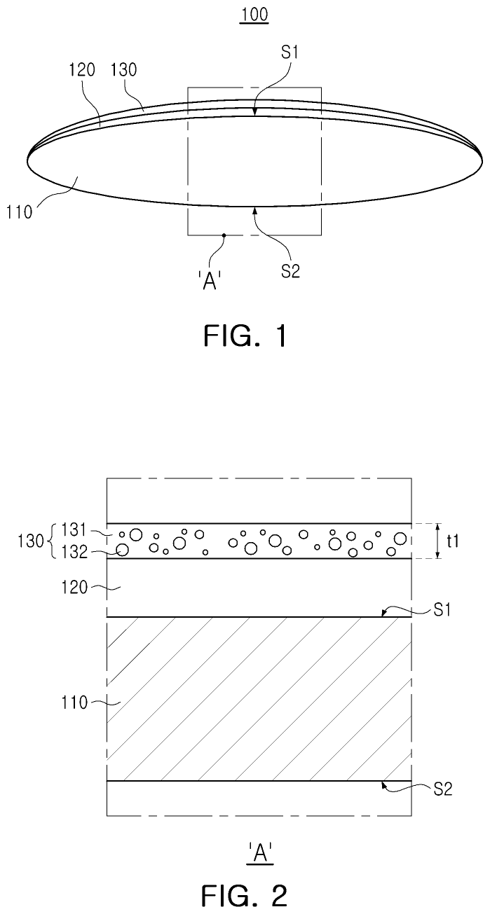

FIG. 1 is a cross-sectional view schematically illustrating a lens according to one or more embodiments of the present disclosure. In addition, FIGS. 2 through 10 are enlarged views of a region of the lens of FIG. 1. First, referring to FIGS. 1 and 2, a lens 100, according to one or more embodiments of the present disclosure, may include a lens unit 110, an antireflective (AR) coating layer 120, and a water-repellent layer 130, in which the water-repellent layer 130 may include a base layer 131 and an ultraviolet (UV) absorber 132. Damage to the water-repellent layer 130 caused by UV light may be reduced by incorporating the UV absorber 132 into the water-repellent layer 130, thereby improving the durability of the water-repellent layer 130. Further, the improved durability of the water-repellent layer 130 may lead to improved reliability of the lens 100. In addition, the lens 100 may have lower reflectivity by employing the AR coating layer 120, thereby preventing a flare phenomenon. Hereinafter, the description describes the major components of the lens 100.

The lens unit 110 is not limited to any particular shape or type, and may be implemented as any lens that can be used in any optical device, such as a camera module. Thus, the lens unit 110 may have a modified shape other than that shown in FIG. 1. The lens unit 110 may be made of a plastic resin, including a resin component. For example, the plastic resin may include at least one of polycarbonate or polyolefin, or combination thereof. Here, polyolefin may include at least one of a cycloolefin polymer and a cycloolefin copolymer. The lens unit 110 may also be made of another material, such as glass.

The intermediate layer 120 may cover at least a portion of a surface of the lens unit 110, and cover a first surface S1 of the lens unit 110 as shown in FIG. 2. The intermediate layer 120 may be a buffer layer, provided as a single layer in an example. When the intermediate layer 120 is provided as the buffer layer, the water-repellent layer 130 covering the intermediate layer 120 may be uniformly formed with a sufficient thickness to effectively protect the lens unit 110. The intermediate layer 120 may be formed using a process such as chemical vapor deposition (CVD) or physical vapor deposition (PVD). In addition, when considering its function as the buffer layer, the intermediate layer 120 may include at least one material layer selected from a group consisting of siloxane, silicon dioxide (SiO₂), silicon oxynitride (SiON), silicon nitride (Si₃N₄), titanium dioxide (TiO₂), titanium oxynitride (TiON), and titanium nitride (TiN). For example, when provided as the material layer including a silicon (Si) group, the intermediate layer can be more effectively coupled with the water-repellent layer 130.

Herein, it is noted that use of the term ‘may’ with respect to an example or embodiment, e.g., as to what an example or embodiment may include or implement, means that at least one example or embodiment exists where such a feature is included or implemented while all examples and embodiments are not limited thereto.

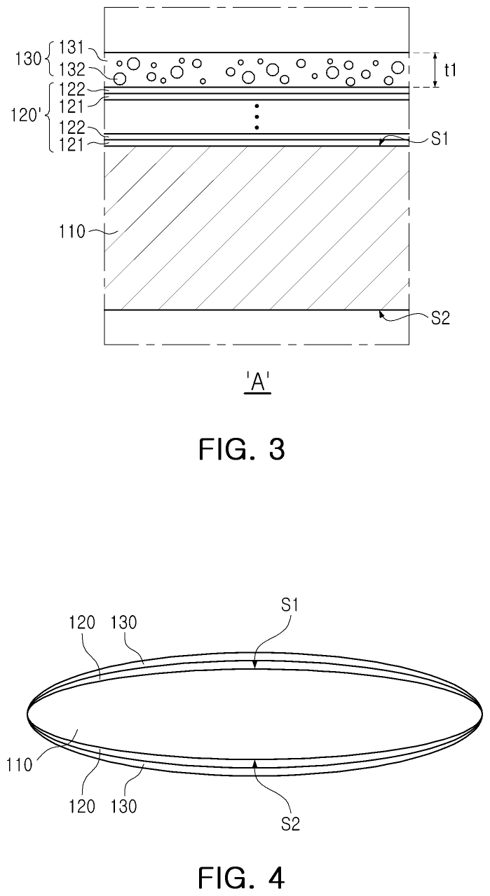

A modified example of FIG. 3 shows that an intermediate layer 120′ may be an antireflective (AR) coating layer. The intermediate layer 120′ may be implemented as the AR coating layer, and the lens 100 may thus have the lower reflectivity, thereby reducing the flare phenomenon. In this case, the intermediate layer 120′ may have a multilayer structure in which a first layer 121 and a second layer 122, having different refractive indices, are alternately stacked one or more times. In more detail, the intermediate layer 120′ may include a structure in which the SiO₂ layer 121 and the TiO₂ layer 122 are repeatedly stacked one or more times.

Meanwhile, the thicknesses of the intermediate layers 120 and 120′ may be measured using both non-destructive and destructive testing. Examples of non-destructive testing may include ellipsometer measurement and reflectometer measurement. As an example of the destructive analysis, transmission electron microscopy (TEM) analysis can be performed after processing a cross-section of the intermediate layer 120 or 120′ by using a focused ion beam (FIB) method. The cross-section of the intermediate layer 120 or 120′ may be taken to include a central portion of the lens unit 110, which may be the thickest region of the lens unit 110. In addition, the thickness of the intermediate layer 120 or 120′ can be defined as a distance measured in a direction perpendicular to its surface, and can be determined as an average value of values measured in a plurality of regions having equal intervals.

The water-repellent layer 130 may cover at least a portion of the entire surface of the intermediate layer 120. For example, the water-repellent layer 130 may cover the surface of the intermediate layer 120, opposite to the first surface S1 of the lens unit 110, positioned on the outside, as shown in FIG. 2. The water-repellent layer 130 may be employed to prevent surface oxidation of the lens unit 110 and the like, and include a base layer 131 and a UV absorber 132. In an example, the UV absorber may be included in the base layer 131. The base layer 131 may be made of an organic material layer to perform a water-repellent function, including a fluorocarbon component with a Si head group.

As described above, the water-repellent layer 130 may include the UV absorber 132; in this case, the UV absorber 132 may be of a particle type. Due to the increasing desire to properly protect the lens 100 from the external environment, as the uses of the lens 100 become more diversified, the desire may be even higher when the lens is always externally exposed, such as in a vehicle's camera. Therefore, with the current disclosure, it is possible to effectively suppress effects of contamination or moisture on the surface of the lens 100 by employing the water-repellent layer 130. However, the water-repellent layer 130 may be damaged due to the UV light incident from sunlight, etc. In this embodiment, to mitigate the effects of UV light, the UV absorber 132 may be employed in the water-repellent layer 130.

As a specific example, the UV absorber 132 may include inorganic particles. Typical UV absorbers may be made using only organic materials, and in this case, the chemical structure of the organic material may deform due to the photon energy of the UV light, which may cause discoloration or deformation of the UV absorber. In the subject disclosure, the discoloration or deformation caused by the UV light is minimized using the UV absorber 132, which may include inorganic particles, thereby improving the reliability and long-term performance of the lens 100. The UV absorber 132 may include the inorganic particles, and in this case, a material included in the inorganic particles may have a smaller energy bandgap than the photon energy in a UV wavelength range. The configuration may be determined by considering that an amount of the UV light transmitted, without being absorbed, increased when the UV absorber 132 uses a material having an energy bandgap larger than that of the photon energy in the UV wavelength range. In more detail, the inorganic particles included in the UV absorber 132 may include at least one selected from a group consisting of a material having a higher absorption rate of the UV light, for example, cerium dioxide (CeO₂), zinc oxide (ZnO), titanium dioxide (TiO₂), and tungsten trioxide (WO₃). However, the UV absorber 132 may not only include the inorganic components and may further include the organic material. The UV absorber 132 may further include the organic material to widen the UV wavelength band capable of being absorbed, thus further improving the UV absorption efficiency. For example, the organic materials which can be included in the UV absorber 132 may include benzophenones, oxalanilides, benzotriazoles, and triazines, and each material may have an advantage of a low cost (in the case of benzophenones), low discoloration (in the case of oxalanilides), high absorbance (in the case of benzotriazoles, triazines), or the like.

The inorganic particle of the UV absorber 132 may include the nano-sized inorganic particle, and here, the nano-sized inorganic particle may have a diameter of 50 nm or less. When having a larger particle size, the UV absorber 132 may have a scattering effect more dominant than an effect of the UV light absorption. According to the research of the present inventors, when having the nano-size, especially a size of 50 nm or less, the UV absorber 132 may have a further improved effect on UV light absorption. However, even in this case, the inorganic particle may have a diameter smaller than the thickness t1 of the base layer 131. Here, the thickness t1 of the base layer 131 may be measured using the non-destructive testing or the destructive testing described above with respect to the intermediate layer 120. However, it may be difficult to use the above-described thickness measurement method when the thickness of the base layer 131 is very small. In this case, the base layer 131 can be distinguished by performing energy dispersive x-ray spectroscopy (EDS) analysis in a thickness direction of the layer during the TEM analysis to determine a component of the base layer 131, such as a fluorine component.

Meanwhile, the water-repellent layer 130 may be obtained by dispersing the inorganic particles in a coating liquid to form the base layer 131 and then applying the same to the surface of the intermediate layer 120. In addition, a particle of the UV absorber 132 may not necessarily have a spherical shape; at least some particles may have a plate shape, a needle shape, or the like. There is a tradeoff relationship between UV absorption and transmittance functions of a lens when the UV absorber 132 is increased. For example, when the content of the UV absorber 132 is increased, it may be advantageous in the UV absorption function of the lens 100, but disadvantageous in its light transmittance function. Considering this condition, the content of the inorganic particles in the UV absorber 132 may have an area ratio of 10% or less to a unit area of the water-repellent layer 130.

The description below further describes lenses with additional modified examples, as shown in FIGS. 4 through 10. First, in the modified example of FIG. 4, a structure in which the intermediate layer 120 and the water-repellent layer 130 are stacked may be positioned on both surfaces of surface S1 of the lens unit 110 and the other surface S2 opposite thereto. That is, the intermediate layer 120 and the water-repellent layer 130 may cover the lens unit 110 on both surfaces S1 and S2 of the lens unit 110. As shown in this modified example, the reliability of the lens may be further improved as the water-repellent layer 130, including the UV absorber 132, is positioned on both the surfaces S1 and S2 of the lens unit 110. The double-sided coating structure shown in the modified example of FIG. 4 may be applied to all of the following embodiments.

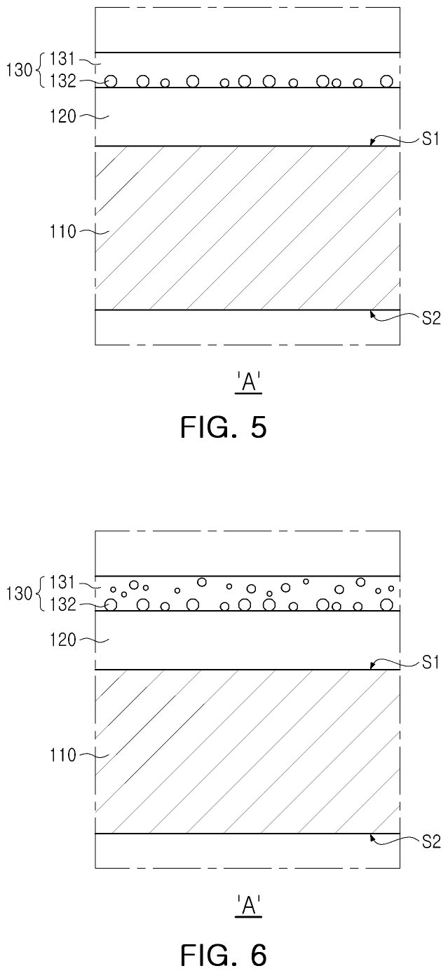

Next, in the modified example of FIG. 5, at least some of the UV absorbers 132 may be in contact with the intermediate layer 120. As shown in the drawing of FIG. 5, the UV absorbers 132 may all be in contact with the intermediate layer 120. Such a contact structure may be implemented by adsorbing the UV absorber 132 to the intermediate layer 120 before forming the base layer 131, having the water-repellent function. It may be easy to adjust the position and content of the UV absorber 132 by using the structure in which the UV absorber 132 is attached to the intermediate layer 120, thus precisely controlling the UV light absorption function of the water-repellent layer 130. In addition, when desired, the water-repellent layer 130 can be designed so that some of the UV absorbers 132 are in contact with the intermediate layer 120 and the rest are not in contact with the UV absorber 132, as shown in the modified example of FIG. 6.

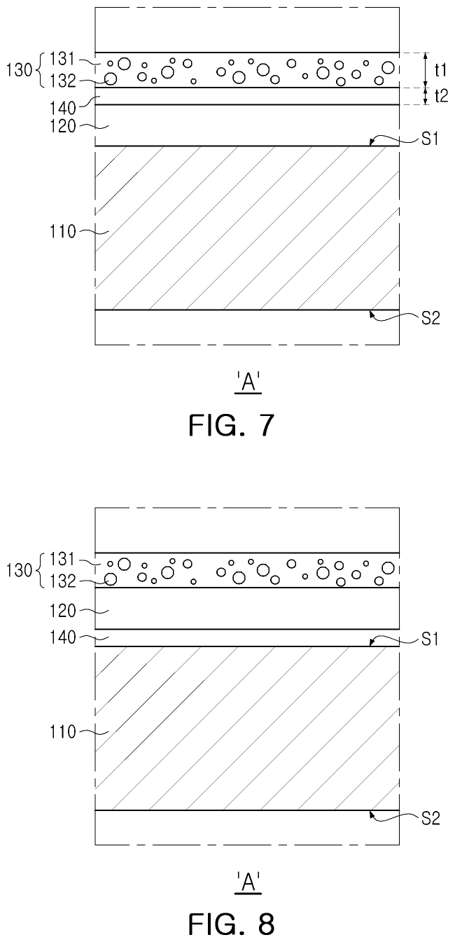

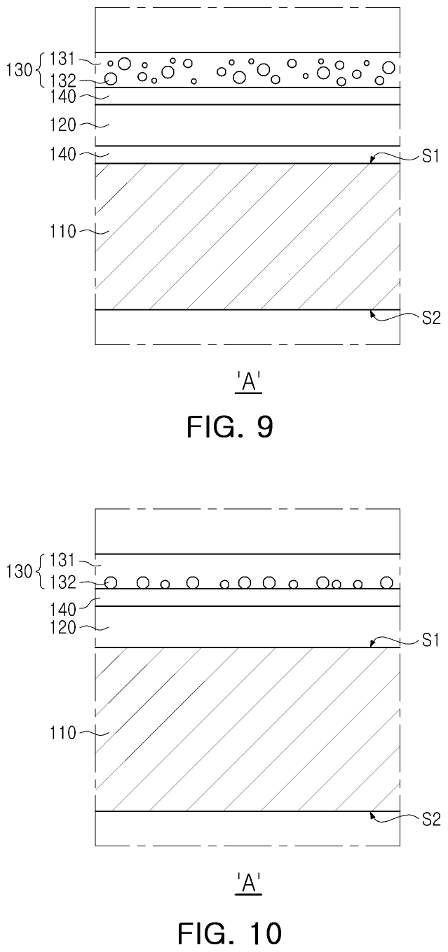

Next, FIGS. 7 through 10 show the modified examples in which a UV absorbing layer 140 is added to further enhance the UV absorbing function. The UV absorbing layer 140 may be disposed between the water-repellent layer 130 and the intermediate layer 120 (see the example of FIG. 7) or disposed between the lens unit 110 and the intermediate layer 120 (see the example of FIG. 8). Alternatively, as shown in FIG. 9, the UV absorbing layer 140 may be disposed both between the water-repellent layer 130 and the intermediate layer 120 and between the lens unit 110 and the intermediate layer 120. When considering an auxiliary function of the UV absorbing layer 140, the UV absorbing layer 140 may have a thickness t2, e.g., 50 nm or less, smaller than the thickness t1 of the water-repellent layer 130. The UV absorbing layer 140 may include the inorganic material. Like the UV absorber 132, the UV absorbing layer 140 may include at least one selected from the group consisting of cerium dioxide (CeO₂), zinc oxide (ZnO), titanium dioxide (TiO₂), and tungsten trioxide (WO₃). As shown in FIG. 10, the UV absorber 132 may be in contact with the UV absorbing layer 140.

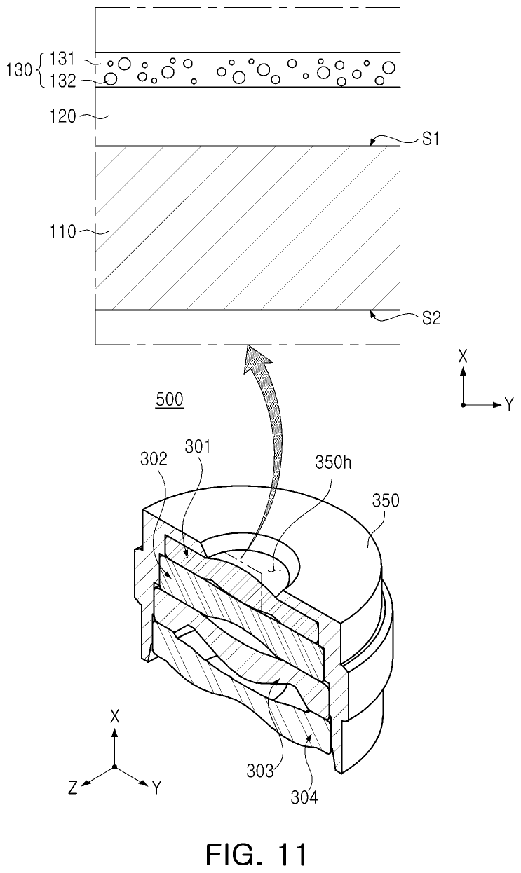

The description describes examples of the above-described lens applied with reference to FIGS. 11 through 15. First, FIG. 11 is a cutaway perspective view schematically illustrating a lens assembly. In this embodiment, a lens assembly 500 may include one or more lenses 301 to 304. In this embodiment, the lens assembly 500 may include four lenses 301 to 304, and the number or shape of each of the lenses 301 to 304 may be changed based on the desired function or size condition thereof. For example, the lens assembly 500 may include a lens barrel 350 having a lens hole 350h in addition to the plurality of lenses 301 to 304. The lens barrel 350 may have a hollow cylindrical shape, and the lens hole 350h for the light transmittance may be formed by passing through one surface of the lens barrel 350. At least one lens 301 among the plurality of lenses 301 to 304 may employ the lens of the above-described embodiment. That is, as shown in the drawing, the lens 301 may include the lens unit 110, the intermediate layer 120, and the water-repellent layer 130, and here, the water-repellent layer 130 may include the base layer 131 and the UV absorber 132. The lens 301, including the water-repellent layer 130 among the plurality of lenses 301 to 304, may be disposed at the outermost side of the lens assembly 500 based on a light incidence side in an optical axis direction (X-direction in the drawing). The outermost lens 301 among the plurality of lenses 301 to 304 may have the greatest influence on the reliability and reflectivity of the lens assembly 500. Therefore, the outermost lens 301 may employ the water-repellent layer 130, and the lens assembly 500 may thus have the maximized durability against the UV light, lowest reflectivity, and the like.

Meanwhile, the lens 301, including the water-repellent layer 130, may have any of various structures described above (e.g., shapes shown in FIGS. 3 through 10) in addition to the shape shown in FIG. 11. In addition, the lens assembly 500 may have improved reliability by applying the same coating part as the lens 301 to at least one of the remaining lenses 302 to 304 other than the outermost lens 301. These various modified structures of the lens assembly 500 may also be applied to a mobile electronic device below.

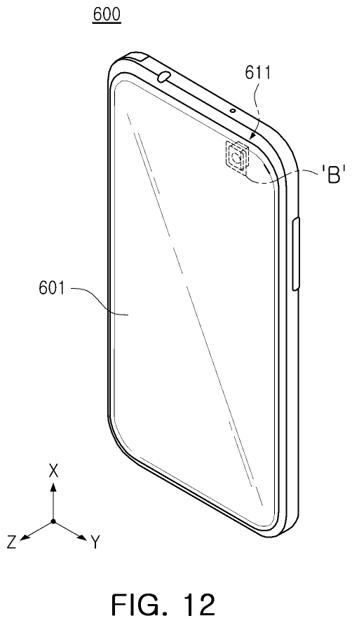

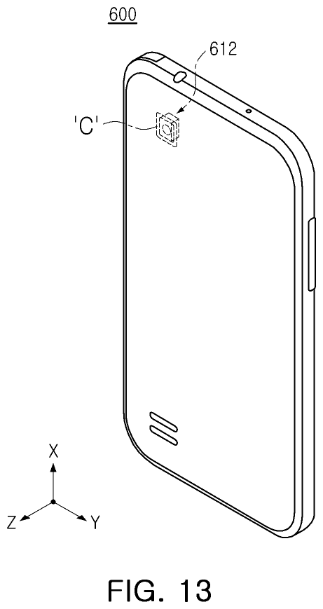

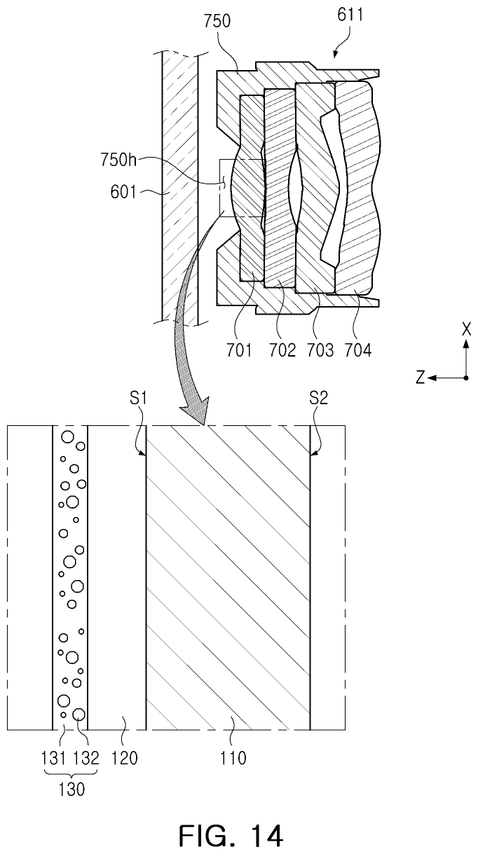

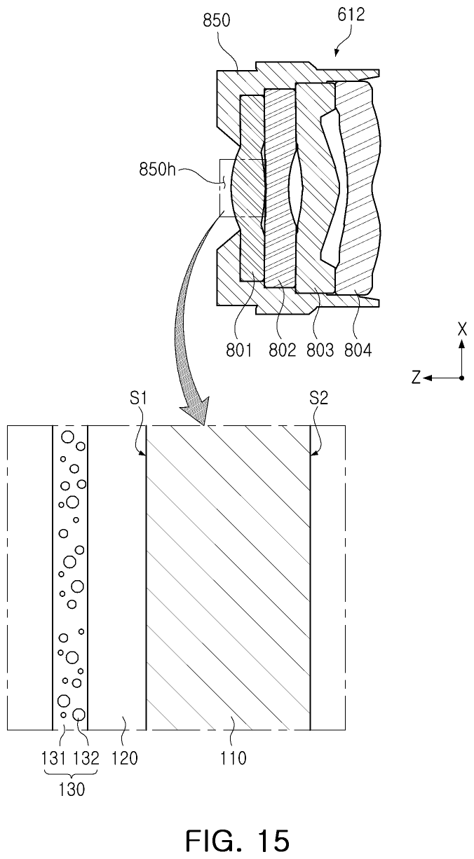

FIGS. 12 and 13 are perspective views schematically illustrating the mobile electronic device, respectively showing its front and rear parts. In addition, FIGS. 14 and 15 are cross-sectional views, respectively, showing enlarged peripheral regions B and C of the lens assembly shown in FIGS. 12 and 13. A mobile electronic device 600 may be provided as any of various electronic devices such as a smartphone, a tablet PC, and a laptop PC, and this embodiment describes the smartphone as a standard. The mobile electronic device 600 may include a display unit 601, a first lens assembly 611, and a second lens assembly 612 as the main components thereof. However, when desired, the mobile electronic device 600 may only include one of the first and second lens assemblies 611 and 612. In addition to the display unit 601 and the lens assemblies 611 and 612, the other main elements (for example, a processing module, a communication module, and a touch sensing module) included in the mobile electronic device 600 may use configurations known in the art, and detailed descriptions thereof are omitted.

The first and second lens assemblies 611 and 612 may each have the structure described with reference to FIG. 11. In detail, the first lens assembly 611 may include a lens barrel 750 having a lens hole 750h in addition to a plurality of lenses 701 to 704. At least one lens 701 among the plurality of lenses 701 to 704 may employ the lens of the above-described embodiment. As shown in the drawing, the lens 701 may include the lens unit 110, the intermediate layer 120, and the water-repellent layer 130; here, the water-repellent layer 130 may include the base layer 131 and the UV absorber 132. In this case, the lens 701, including the water-repellent layer 130 among the plurality of lenses 701 to 704, may be disposed at the outermost side of the lens assembly 611 in a light incidence direction, that is, in the optical axis direction (Z-direction in the drawing). Similarly, the second lens assembly 612 may include a lens barrel 850 having a lens hole 850h in addition to a plurality of lenses 801 to 304. At least one lens 801 among the plurality of lenses 801 to 804 may employ the lens of the above-described embodiment. As shown in the drawing, the low-reflection lens 801 may include the lens unit 110, the intermediate layer 120, and the water-repellent layer 130, and here, the water-repellent layer 130 may include the base layer 131 and the UV absorber 132. In this case, the lens 801, including the water-repellent layer 130 among the plurality of lenses 801 to 804, may be disposed at the outermost side of the first lens assembly 811 in the light incidence direction, that is, in the optical axis direction (Z-direction in the drawing).

As shown in the drawing, the first lens assembly 611 may be covered by the display unit 601, for example, by a tempered glass part of the display unit 601. However, the tempered glass may not need to be a part of the display unit 601 when the tempered glass covers the first lens assembly 611. As such, the amount of light incident on the lens may be reduced when the first lens assembly 611 is covered by the display unit 601 or the like, and the reflectivity of the first lens assembly 611 may have a greater influence on the performance of the camera module. In other words, in the case of the front part of the mobile electronic device 600, the first lens assembly 611 may be covered by the display unit 601, which corresponds to a so-called under display camera (UDC) structure. The UDC structure may reduce camera hole processing. However, an additional tempered glass may be disposed on the camera to implement the UDC structure to reduce the amount of light incident on the camera, which may cause lower camera performance. Therefore, the camera module may perform significantly lower when the reflectivity of the lens is high in the UDC structure. As in this embodiment, it is possible to maximize the reflectivity reduction effect of the first lens assembly 611 by arranging the lens 701 closest to the light incidence side, that is, the display unit 601, thereby improving the performance of the camera module, including the same. This reflectivity reduction effect can be further improved when the intermediate layer 120 is implemented as the AR coating layer. Meanwhile, the above example describes the case where the first lens assembly 611 is covered by the display unit 601 or the like. However, in some embodiments, the second lens assembly 612 may also be covered by an optical element that may cause loss of light amount, for example, by tempered glass or the like. In this case, the reflectivity reduction effect of the second lens assembly 612 may be more important.

As set forth above, the lens according to one or more embodiments of the present disclosure may have the improved reliability by including the coating structure with the improved durability against the external environment such as the UV light.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens comprising:
a lens unit;
an intermediate layer configured to cover a surface portion of the lens unit; and
a water-repellent layer, configured to cover a surface portion of the intermediate layer, comprising a base layer and an ultraviolet (UV) absorber disposed in the base layer.

2. The lens of claim 1, wherein the UV absorber includes inorganic particles.

3. The lens of claim 2, wherein the inorganic particles include at least one selected from a group consisting of cerium dioxide (CeO₂), zinc oxide (ZnO), titanium dioxide (TiO₂), and tungsten trioxide (WO₃).

4. The lens of claim 2, wherein the inorganic particle includes a nano-sized inorganic particle.

5. The lens of claim 4, wherein the nano-sized inorganic particle has a diameter of 50 nm or less.

6. The lens of claim 2, wherein a diameter of the inorganic particle is smaller than a thickness of the base layer.

7. The lens of claim 2, wherein the UV absorber further includes an organic material.

8. The lens of claim 2, wherein the inorganic particles in the UV absorber have an area ratio of 10% or less to a unit area of the water-repellent layer.

9. The lens of claim 1, wherein the intermediate layer includes at least one material layer selected from a group consisting of siloxane, silicon dioxide (SiO₂), silicon oxynitride (SiON), silicon nitride (Si₃N₄), titanium dioxide (TiO₂), titanium oxynitride (TiON), and titanium nitride (TiN).

10. The lens of claim 1, wherein the intermediate layer has a multilayer structure comprising a first layer and a second layer, having different refractive indices, and are alternately stacked one or more times.

11. The lens of claim 1, wherein a portion of the UV absorber is in contact with the intermediate layer.

12. The lens of claim 11, wherein all of the UV absorber is in contact with the intermediate layer.

13. The lens of claim 1, further comprising a UV absorbing layer disposed between either one or both of the water-repellent layer and the intermediate layer, and the lens unit and the intermediate layer.

14. The lens of claim 13, wherein a thickness of the UV absorbing layer is smaller than a thickness of the water-repellent layer.

15. The lens of claim 13, wherein the UV absorbing layer includes an inorganic material.

16. The lens of claim 13, wherein the UV absorber is disposed to contact the UV absorbing layer.

17. A mobile electronic device comprising,
a lens assembly comprising one or more lenses, wherein at least one lens among the one or more lenses comprises the lens of claim 13; and
a display unit disposed on the lens assembly.

18. A lens assembly, comprising:
one or more lenses, wherein at least one lens among the one or more lenses includes
a lens unit,
an intermediate layer configured to cover a surface portion of the lens unit, and
a water-repellent layer, configured to cover a portion of the intermediate layer, comprising a base layer and an ultraviolet (UV) absorber disposed in the base layer.

19. The lens assembly of claim 18, wherein the at least one lens is disposed on an outermost side of the lens assembly in an optical axis direction.

20. A mobile electronic device, comprising:
a display unit; and
a lens assembly comprising one or more lenses, and at least one lens among the one or more lenses includes
a lens unit,
an intermediate layer configured to cover a surface portion of the lens unit, and
a water-repellent layer, configured to cover a portion of the intermediate layer, comprising a base layer and an ultraviolet (UV) absorber disposed in the base layer.

21. The device of claim 20, wherein the at least one lens is disposed on an outermost side of the lens assembly in the optical axis direction.

22. The device of claim 20, wherein the lens assembly is covered by the display unit.

23. The device of claim 20, wherein the lens assembly is covered by tempered glass.
